(19) United States
(12) Patent Application Publication
(10) Pub. No.: US 2017/0022821 A1
(43) Pub. Date: Jan. 26, 2017

(54) BLADE ASSEMBLY FOR A TURBOMACHINE ON THE BASIS OF A MODULAR STRUCTURE

(71) Applicant: GENERAL ELECTRIC TECHNOLOGY GMBH, Baden (CH)

(72) Inventors: Joergen FERBER, Wutöschingen (DE); Dmitry YAKUSHKOV, Moscow (RU); Kseniya DENISOVA, Moscow (RU)

(73) Assignee: General Electric Technology GmbH, Baden (CH)

(21) Appl. No.: 15/039,296

(22) PCT Filed: Nov. 24, 2014
(86) PCT No.: PCT/EP2014/075400

§ 371 Date: May 25, 2016

(30) Foreign Application Priority Data
Nov. 25, 2013 (EP) 13194248.4

(51) Int. Cl. F01D 5/14; F01D 5/18

(52) U.S. Cl. CPC F01D 5/147; F01D 5/187; F05D 2230/51; F05D 2240/40; F05D 2240/307; F05D 2230/237; F05D 2260/231; F05D 2260/201; F05D 2260/202

(57) ABSTRACT

A blade assembly of a power plant having a modular structure, wherein blade elements include at least one blade airfoil, and at least one footboard mounting part. Blade elements can each have at its one ending a configuration for an interchangeable connection among each other. The connection of the airfoil with respect to other elements can be based on a fixation in radially or quasi-radially extension relative gas turbine axis, wherein the assembling of the blade airfoil in connection with the footboard mounting part is based on a friction-locked bonding actuated by adherence interconnecting, or on use of a metallic and/or ceramic surface fixing blade elements to each other, or on closure configuration with a detachable, permanent or semi-permanent fixation.

### TECHNICAL FIELD

The present invention relates to a blade assembly for a turbomachine, preferably a gas turbine engine, and refers in particular to a modular blade with one or more removable elements or modules. The term blade is to define in a broad sense. Though the invention preferably refers to rotor blades, the invention is not limited to this category, but additionally relates to guide vanes and similar components of turbomachines.

Basically, the modular blade assembly of the present invention comprises various interchangeable modules or elements, wherein the mentioned parts being substitutable, semi-substitutable or non-substitutable.

According to the invention a blade assembly on the basis of a modular structure at least comprises a blade airfoil, a footboard mounting part, wherein the elements of the modular structure of the blade having at its one endings means for the purpose of an interchangeable connection among each other. The connection of the airfoil with respect to the other elements is based on a fixation in radial or quasi-radial direction in relation to the rotor axis of the turbomachine, wherein the assembling of the blade airfoil in connection with the footboard mounting part is based on a friction-locked bonding actuated by adherence interconnecting, or the assembling of the blade airfoil in connection with the footboard mounting part is based on the use of a metallic and/or ceramic surface fixing blade elements to each other, or the assembling of the blade airfoil in connection with the footboard mounting part is based on force closure means with a detachable, permanent or semi-permanent fixation.

Cooling passages extend inside the blade airfoil for cooling purposes and are supplied with a cooling medium, particularly cooling air, via a feed hole which is arranged on the shank at its side or directly via the blade root portion.

The detachable or permanent connection between the modules comprising a force-closure means consists of bolts or rivets, or is made by HT brazing, active brazing, soldering etc.

### BACKGROUND OF THE INVENTION

According to US 2011/0142684 A1 a rotor blade airfoil is formed by a first process using a first material. A platform is formed by a second process using a second material that may be different from the first material. The mentioned platform is assembled around a shank of the airfoil. One or more pins extend from the platform into holes in the shank. The platform may be formed in two portions and placed around the shank, enclosing it. The two platform portions may be bonded to each other. Alternately, the platform may be cast around the shank using a metal alloy with better castability than that of the blade and shank, which may be specialized for thermal tolerance. The pins bear load from the under section of the airfoil.

According to US 2011/0142639 A1 a turbine airfoil extends from a shank. A platform brackets or surrounds a first portion of the shank Opposed teeth extend laterally from the platform to engage respective slots in a disk. Opposed teeth extend laterally from a second portion of the shank that extends below the platform to engage other slots in the disk. Thus the platform and the shank independently support their own centrifugal loads via their respective teeth. The platform may be formed in two portions that are bonded to each other at matching end-walls and/or via pins passing through the shank. Coolant channels may pass through the shank beside the pins.

EP 2 189 626 B1 refers to a rotor blade arrangement, especially for a gas turbine, which rotor blade arrangement can be fastened on a blade carrier and comprises in each case a blade airfoil element and a platform element, wherein the platform elements of a blade row forms a continuous inner shroud. With such a blade arrangement a mechanical decoupling, which extends the service life, is achieved by blade airfoil element and platform element being formed as separate elements and by being able to be fastened in each case separately on the blade carrier.

US 2011/268582 A1 relates to a blade comprises a blade airfoil which extends in the longitudinal direction of the blade along a longitudinal axis. The blade airfoil, which is delimited by a leading edge and a trailing edge in the flow direction, merges into a shank at the lower end beneath a platform which forms the inner wall of the hot gas passage, the shank terminating in a customary blade root portion with a fir-tree-shaped cross-sectional profile by which the blade can be fastened on a blade carrier, especially on a rotor disk, by inserting into a corresponding axial slot (see, for example, FIG. 1 of U.S. Pat. No. 4,940,388).

It is notorious and state of the art that a rotor blade having cooling passages which extend inside the blade airfoil for cooling the blade and are supplied with a cooling medium, particularly cooling air.

Referring to the cited US document cooling passages (not shown) extend inside the blade airfoil for cooling the blade and are supplied with a cooling medium, particularly cooling air, via a feed hole which is arranged on the shank at the side. The shank, similar to the blade airfoil, has a concave and a convex side. The feed hole, which extends obliquely upwards into the interior of the blade airfoil, opens into the outside space on the convex side of the shank. In order to reduce the mechanical stresses which are associated with the mouth of the feed hole and at the same time to positively influence the vibration behaviour of the blade, provision is made around the mouth of the feed hole for a planar or virtually planar-that is to say not formed consistently planar over the entire surface-stiffening element which reaches beyond the direct vicinity of the feed hole, which stiffening is formed integrally on the shank and consists of the same material as the blade. As is to be seen from the cross section of the stiffening element which is shown in FIG. 3, the stiffening element is formed as a large-area plateau, and from the opening of the feed hole arranged to the left of the center plane reaches far beyond the center plane of the blade so that the stiffening element is formed symmetrically to the center plane and also encompasses the mouth of the feed hole.

Referring to US 2013/0089431 A1 a blade airfoil for a turbine system is disclosed. The blade airfoil includes a first body having exterior surfaces defining a first portion of an aerodynamic contour of the blade airfoil and made from a first material. The blade airfoil further includes a second body having exterior surfaces defining a second portion of an aerodynamic contour of the blade airfoil, the second body coupled to the first body and formed from a second material having a different temperature stability compared to the first material. In another embodiment, a nozzle for a turbine section of a turbine system is disclosed. The nozzle includes a blade airfoil having exterior surfaces defining an aerodynamic contour, the aerodynamic contour comprising a pressure side and a suction side extending between a leading edge and a trailing edge. The blade airfoil includes a first body having exterior surfaces defining a first portion of the aerodynamic contour of the blade airfoil and formed from a first material. The blade airfoil further includes a second body having exterior surfaces defining a second portion of the aerodynamic contour of the blade airfoil, the second body is coupled to the first body and formed from a second material having a different temperature stability compared to the first material. The accompanying drawings of this US document, especially FIGS. 3 through 6, together with description, illustrate embodiments and explain the principles of this state of the art.

U.S. Pat. No. 5,700,131 shows an internally cooled turbine blade for a gas turbine engine that is modified at the leading edge and trailing edge to include a dynamic cooling air radial passageway with an inlet at the root portion and a discharge at the tip feeding a plurality of radially spaced film cooling holes in the blade airfoil surface. Replenishment holes communicating with the serpentine passages radially spaced in the inner wall of the radial passage replenish the cooling air lost to the film cooling holes. The discharge orifice is sized to match the backflow margin to achieve a constant film-hole coverage throughout the radial length. Trip strips may be employed to augment the pressure drop distribution. Also well known by those skilled in this technology is that the engine's efficiency increases as the pressure ratio of the turbine increases and the weight of the turbine decreases. Needless to say, these parameters have limitations. Increasing the speed of the turbine also increases the blade airfoil loading and, of course, satisfactory operation of the turbine is to stay within given blade airfoil loadings. The blade airfoil loadings are governed by the cross sectional area of the turbine multiplied by the velocity of the tip of the turbine squared, or AN<2>. Obviously, the rotational speed of the turbine has a significant impact on the loadings. The spar/shell construction contemplated by this invention affords the turbine engine designer the option of reducing the amount of cooling air that is required in any given engine design. And in addition, allowing the designer to fabricate the shell from exotic high temperature materials that heretofore could not be cast or forged to define the surface profile of the blade airfoil section. In other words, by virtue of this invention, the shell can be made from Niobium or Molybdenum or their alloys, where the shape is formed by a well-known electric discharge process (EDM) or wire EDM process. In addition, because of the efficacious cooling scheme of this invention, the shell portion could be made from ceramics, or more conventional materials and still present an advantage to the designer because a lesser amount of cooling air would be required.

EP 2 642 076 shows a connecting system for metal components and CMC components, a turbine blade retaining system and rotating component retaining system are provided. The connecting system includes a retaining pin, a metal foam bushing, a first aperture disposed in the metal component, and a second aperture disposed in the ceramic matrix composite component. The first aperture and the second aperture are configured to form a through-hole when the metal component and the ceramic matrix composite component are engaged. The retaining pin and the metal foam bushing are operably arranged within the through-hole to connect the metal component and the ceramic matrix composite component.

U.S. Pat. No. 7,972,113 B1 shows an airfoil portion 11, as seen in FIG. 2, having a curvature in which the airfoil portion includes both curvature and twist extending from the platform to the blade tip. The airfoil 11 also can include one or more cooling air passages 15 to provide cooling air for the blade. The cooling air passages 15 can be radial passages or a series of serpentine flow passages. The airfoil root with the dovetail 12 is pinched between two platform halves 21 and 22 to form the blade assembly 10. Each of the platform halves 21 and 22 includes an opening 25 on the inner surface that forms the slot to receive the dovetail 12 of the airfoil 11 and a top or flow forming surface 23. As seen in FIG. 2, the openings 25 in the platform halves 21 and 22 extend around the airfoil 11 on both the leading edge trailing edges and both the pressure and suction sides. The dovetail 12 in the airfoil 11 also has the shape of the dashed lines in FIG. 2 that represent the slots 25 formed within the platform halves 21 and 22. The dovetail 12 and slots 25 are shaped and sized so that the dovetail 12 will fit tightly within the slots 25 between the platform halves 21 and 22 when the platform halves are fastened together. Each platform halve 21 and 22 includes at least one hole 24, as seen in FIGS. 1 and 3, to receive a fastener, such as a threaded bolt and a top or flow forming surface 23. If a threaded bolt is used to secure the platform halves together, then at least one hole 24 opposite to the bolt head would include threads as well. The openings of the footboard mounting elements (120, 130) do not extend around the airfoil on both the leading edge trailing edges and both the pressure and suction sides, but in the axis of the gas turbine.

### SUMMARY OF THE INVENTION

The present invention provides a structure or architecture of a blade for a turbomachine, assembled from a plurality of interchangeable modules or elements optimized to the various operation regimes of the turbomachine.

In a separate process the various modules or elements may be repaired and/or reconditioned.

On the basis of the claims:

Especially by using a blade which can be assembled by at least two separate parts, i.e. a separate blade airfoil and footboard mounting part(s), appropriate preconditions can be created to provide interchangeability or repairing and/or reconditioning of the identified separate parts, modules, elements, without replacing the whole blade.

Usually, the inner platform forms an integral part of the blade. According to the fact that during operations at elevated temperatures thermal stress is induced into the transition element(s) from the blade airfoil to the inner platform of the blade. This means, that thermal stresses developing at the leading edge and the trailing edge of the blade airfoil can produce local failure(s) in the used material or at least increase the reconditioning effort.

Accordingly, the modular blade assembly on the basis of a modular structure according to the invention comprises substantially heat shield, blade airfoil, inner platform, shank and footboard mounting part(s). The blade airfoil and/or the inner platform and/or the heat shield and/or the shank and/or the footboard mounting part have at its one end means for the purpose of an interchangeable connection of the mentioned modules to each other, wherein the used connection of the blade modules among one another have a permanent or semi-permanent fixation of the blade airfoil in radial or quasi-radial extension with respect to the axis of the turbomachine rotor. The assembling of the blade airfoil in connection with the other modules, especially with respect to the separated inner platform, is based, directly or indirectly, on a friction-locked bonding actuated by adherence interconnecting, or on a force-fit or form-fit connection, or using a shrinking joint.

Thus, the structure of the blade includes substantially a blade airfoil, an inner platform, a fir-tree-shaped cross-sectional profile by which the blade can be fastened on a blade carrier or directly on a rotor disk as main modules with additional sub-modules, especially an intermediate shank between the inner platform and the footboard mounting part(s), also called root portion, having preferentially a fir-tree-shaped cross-sectional profile. As an additional sub-module of the blade airfoil the tip comprises a heat shield with seal means.

Main-modules of the separated inner platform and blade airfoil are assembled by joining at least two parts of the inner platform with placing the blade airfoil between them before mounting the fir-tree root portion. The modules may be sealed to each other by ceramic, seal ropes or similar embodiments.

The blade platform is separated in axial direction. In contrast, the state of the art suggests a separation of the platform into a pressure side portion and a suction side portion.

In particular this embodiment in accordance with the state of the art, namely US 2011/0142639 A1, is designed so that the blade assembly, including a blade or blade airfoil, has a pressure side, a suction side, a shank, a platform, having a pressure side portion and a suction side portion, each comprising a root portion with at least one laterally extending tooth that engages into the rotor disk. After assembly, the platform surrounds or brackets a first portion of the shank. A second portion of the shank extends outside the platform, or radially inward of the platform when mounted in a turbine disk. The part of the shank outside the platform has at least two opposed laterally extending teeth that engage into the rotor disk.

The identified embodiment comprises pins on one or both platform portions that pass through pin holes inside of the shank. The pins may be bonded to the opposite platform portion after assembly. The pins connect the two platform portions. The pins may fill the holes and thus provide load sharing between the shank and the platform.

Thus, the separation of the platform in axial direction in accordance with the present invention bears their loads and airfoil bears its loads and involves a completely new philosophy in connection with the modular structure of a blade.

In accordance with the present invention, the blade shank under-structure consists, in radial direction of the airfoil, of an elongated and relatively slim formed portion. The elongated portion extends over the entire height of the footboard mounting part(s), wherein the foot-side end of the elongated portion has, with respect to both sides of the axial expanse of the elongated portion, a shape of teeth configuration, and the bottom of the elongated portion of the shank under-structure may be formed as the final part of the fir-tree-shaped cross-sectional profile. The teeth of the elongated portion of the shank under structure may align with the recesses of two-folded footboard mounting elements to provide room for the teeth of the elongated portion.

The term “radial” or “radially” as used herein, is intended to mean radial to the gas turbine rotor axis, when the blade assembly is installed in its operational position.

Moreover, the footboard mounting parts have axially opposite cracks or clutches corresponding to the axially extending contour of the elongated portion of the shank under-structure for the reciprocal axial coupling.

Additional geometric features, such as grooves, may be provided on the elongated portion of the shank under-structure for interlocking with the both footboard mounting elements.

The assembling of mentioned elements is based generally on a friction-locked bonding actuated by adherence interconnecting, or is based on the use of a metallic and/or ceramic surface fixing blade elements to each other, or is based on force-fit or form-fit or shrinking joint connection, or is based on force closure means with a detachable or permanent connection. Additionally, one or more mechanical fixing means may be inserted into the connection area, wherein the mechanical fixing means are provided as separate parts and they can be cast into the connection area with a perfect fit connection.

Another aspect of the invention regards supplement means for a sealing structure, wherein the sealing structure must be designed preferably as joining without force transmission between blade airfoil and platform element(s), wherein the platform element(s) comprise additional sub-modules. Different types of sealing structure come into consideration:

1. A “rope seal” as is described for example in U.S. Pat. No. 7,347,424 B2. In this case, there are leakage losses, however.

2. A “brush seal” Also in this case, leakage losses have to be taken into consideration.

3. A temperature-resistant filing material for ensuring a 100%-sealing without leakage losses with simultaneous avoidance of force transmission, for example by means of superplastic material.

4. Other seals are also conceivable, which are suitable for this application purpose.

Especially by using a blade which can be assembled by at least two separate parts, i.e. blade airfoil comprising an elongated portion of the shank under-structure on the one hand, and separated coupling footboard mounting elements on the other hand, preconditions are created to provide an interchangeability or repairing and/or reconditioning of the identified separate parts, modules, elements, without replacing the whole blade.

Basically, it is also possible to parcel out blades in various separate elements or modules, i.e. with respect to heat shield, blade airfoil, inner platform and footboard mounting part(s). If the blade comprises an intermediate shank between inner platform and footboard mounting part(s) the same implementation can be applied.

Significant thermal stress concentration can be avoided by decoupling the separated coupling footboard mounting parts in axially direction from the blade airfoil and elongated portion of blade shank under structure.

In addition, with decoupling these parts also different degrading mechanism can be separated, like oxidation of the inner platform from the low cycle fatigue of the blade airfoil portion. By decoupling the parts from each other, both have to carry themselves in corresponding carrier. The same proceeding can be adopted with respect to the heat shield.

In case of a fixed position of the blade, by at least one fixing means at the inner end of the blade airfoil, the blade airfoil stays in close contact or is connected in one piece with the inner platform, which borders the hot gas flow through the turbine stage towards the inner diameter of the hot gas flow channel of the turbine stage. On the other hand, the inner platform, which is directly or indirectly connected with the blade airfoil in a flush manner, is manufactured in one piece with the blade airfoil and borders the hot gas flow channel radially outwards.

Alternatively, the assembling of the blade airfoil in connection with the mentioned interdependent modules is based on the use of a metallic and/or ceramic surface fixing the blade modules to each other. Further alternatively, the assembling of the blade airfoil in connection with the other modules based on force-fit or form-fit or shrinking joint, or force closure means with a detachable or permanent connection, wherein at least one blade airfoil comprises at least one outer hot gas path liner, hereinafter called shell, encasing at least one part of the blade airfoil.

The shell itself represents the aero profile of the blade airfoil and consists of an interchangeable module with various variants in cooling and/or material configurations and/or corporal compounding adapted to the different operating regimes of the turbomachine, e.g. gas turbine.

Accordingly, the blade comprises a blade airfoil, having at its one end radial or quasi-radial means for inserting it into a recess and/or boost of an inner platform for the purpose of a detachable or semi-detachable or permanent or quasi-permanent connection resp. fixation, being independent on the elongated portion of the shank under-structure and footboard mounting part(s).

This fixation can be made by means of a friction-locking actuated by adherence or through the use of a metallic and/or ceramic surface coating, or by a force closure means consisting of bolts or rivets, or made by HT brazing, active brazing or soldering.

The same proceeding is also applied to the blade airfoil with respect to the heat shield, wherein the inner and outer modules can be consisted of one piece or a composite structure.

According to individual operative requirements or individual operating regimes of a turbomachine, e.g. a gas turbine, particularly the footboard mounting part(s), the inner platform, or the footboard mounting part(s) include an integrated inner platform, blade airfoil, heat shield comprising additional means and/or inserts, which are able to withstand the thermal and physical stress, wherein the mentioned means and inserts are holistically or on their part interchangeable.

However, it must be ensured that the inner platform and the heat shield of the blade of the first row are aligned adjacent to each other in circumferential direction limiting an annular hot gas flow in the region of the inlet of the turbine stage.

In case of a solely detachable fixation between the inner end of the blade airfoil and inner platform, as mentioned before in connection with a preferred embodiment, the inner platform provides at least one recess for the insertion of the hook like extension or lug of the blade airfoil at its radially end(s) so that the blade airfoil is fixed at least in axial and circumferential direction of the turbine stage. Also in such a case the axial coupling between both footboard mounting parts and the elongated portion of the shank can be installed.

Additional geometric features, namely variously designed grooves, may be provided on the elongated portion of the shank under-structure for interlocking with both footboard mounting parts.

The hook like extension has a cross like cross section which is adapted to a groove inside the inner platform. The recess inside the inner platform provides at least one position for insertion or removal at which the recess provides an opening through which the hook like extension of the blade airfoil can be inserted completely only by radial movement. The shape of the extension of the blade airfoil and the recess in the inner platform is preferably adapted to each other like a spring nut connection.

For insertion or removal purpose it is possible to handle the blade airfoil only at its radially outwardly directed end which is a remarkable feature for performing maintenance work at the turbine stage.

It is feasible that the inner platform is detachably mounted to an intermediate piece, for example to a shank, or directly to the footboard mounting part which is also detachably mounted to the inner structure respectively inner component of the turbine stage. Hereto, the intermediate piece provides at least one recess for insertion a hook like extension of the inner platform for axially, radially and circumferentially fixation of the inner platform.

The mentioned intermediate piece may be structured for an axially directed coupling like the coupling of both footboard mounting parts.

Basically, the intermediate piece allows some movement of the inner platform in axial, circumferential and radial direction. There are some axial, circumferential and radial stop mechanisms in the intermediate piece to prevent the inner platform from unrestrained movements. With the axial and circumferential stop mechanism the blade airfoil of the blade is not cantilevered but supported at the outer and inner platform. An additional spring type feature presses the inner platform against a radial stop mechanism within the intermediate piece, so that the blade airfoil can be mounted into the outer and inner platform by sliding the blade airfoil radially inwards from a space above the heat shield liner.

Furthermore, a manner of attaching the blade airfoil and outer shell or outer shell portions to the inner platform respectively heat shield consisting of a recess provided in the heat shield.

Likewise, the radial end of the blade airfoil can be introduced in a recess of the inner platform. The mentioned recesses can be substantially blade-airfoil shaped, corresponding to the outer contour of the blade airfoil or blade airfoil assembly. Thus, the blade airfoil and blade airfoil assembly include at least one outer shell arrangement which can be trapped between the inner platform and the heat shield.

Moreover, existing solutions according to the mentioned state of the art under section “Background of the Invention” cover only parts of the object of the present invention. A further important feature of the invention in connection with the operating aspects of the blade airfoil comprises at least one outer shell and, if necessary, at least one no flow-applied intermediate shell for modular alternatives of the original blade airfoil.

The function of the blade airfoil carrier pertains to carrying mechanical load from the blade airfoil module. In order to protect the blade airfoil carrier with respect to the high temperature and separate thermal deformation from the blade airfoil module, an outer and, additionally, an intermediate hot gas path shell, also called intermediate shell, may be introduced.

Accordingly, the intermediate shell is in any case optional in relation to the operating aspect of the blade. It may be required as compensator for potentially different thermal expansion of outer shell and spar understructure and/or cooling shirt for additional protection of the spar. The outer shell is joined to the optional intermediate shell or spar generally by interference fit or force-fit or form-fit, and the intermediate shell is also joined to the spar by interference fit, force-fit, form-fit or using a shrinking joint.

The spar, including the tip cap, is manufactured by additive manufacturing methods, and includes a cooling configuration which additionally cools the spar.

Furthermore, the intermediate shell provides, additionally, a protection to the spar understructure or airfoil contour in case of damage of the outer shell. Basically, the intermediate shell is an interchangeable module with many variations referring to cooling methods and/or material configurations, with the aim that the shell(s) is adapted to the different operating regimes of the gas turbine.

If several superimposed shells are provided, they may be built with or without spaces between them.

The internal cooling of the shells can be individually provided, or the cooling being operatively connected with the inner cooling of the blade airfoil.

The mentioned shells may consist of at least two segments. Preferably, the segments, forming the shell, are connected together so as to permit assembly and disassembly of shell, shell components, blade airfoil and various other components of the blade.

Fundamentally, the complete shell includes a leading edge and a trailing edge in conformity with the structure and aero profile of the blade airfoil.

It is possible to compensate or reduce local differences in flow-applied and incoming flow onto the individual blade on the basis of a particular positioning of the respective blade row. It is in this way possible, inter alia, to reduce the excitation of oscillations in the blade region.

In any damage event the repair of the flow-applied outer shell involves the replacement of the single damaged subcomponents, but not the entire replacement of the blade airfoil. The modular design facilitates the use of various materials in the shell, including materials with different physical values. Thus, suitable materials can be selected within the shell components to optimize component life, cooling air usage, aerodynamic performance, and costs.

The flow-applied shell assembly can further include a seal provided between a recess and at least one of the radial ending of the shell and the outer peripheral surface of the blade airfoil proximate the radial end. As a result, hot gas infiltration or cooling air leakage, except when an effusion cooling is provided, can be excluded, if the shell segments can be brazed or welded along their radial interface at or near the outer peripheral surface so as to close the gaps. Alternatively, the gaps can be filled with a compliant insert or other seal (rope seal, tongue and groove seal, sliding dovetail, etc.) to prevent hot gas ingress and migration through the gaps. In all cases, the interchangeability or repairing and/or reconditioning of the single shell or shell components is to be maintained.

The gap or groove of the radial interface of the single shell components can be filled with a ceramic rope and/or a cement mixture can be used. An alternative consists of a shrinking shell or shell components on the blade airfoil. If in such a case the interchangeability or repairing and/or reconditioning of the shell or shell components are not guaranteed, it must be ensured that the entire blade airfoil arrangement can be replaced.

Both, inner platform and heat shield can be formed similar to components or subcomponents of the blade airfoil.

Especially, the mentioned inner platform can consist of at least two segments. Preferably, the components forming the inner platform are connected together or to the blade airfoil and/or shell components, so as to permit assembly and disassembly of this inner platform.

The hot gas loaded (flow-applied) side of platforms is equipped with one or more fixed or removable inserts. The insert equipment forming an integral coverage or capping with respect to the hot gas loaded area.

The mentioned insert equipment has a coating surface, which is able to resist the thermal and physical stresses, wherein the mentioned equipment comprises inserts that are holistically or on their part interchangeable.

The gap or groove of the axial and or radial interface of the single inserts within the outer and inner platform can be filled with a ceramic rope and/or a cement mixture can be used. An alternative consists of shrinking capping components on the mentioned platforms. If in such a case the interchangeability or repairing and/or reconditioning of inserts are not guaranteed, it must be ensured that the entire platform can be replaced.

Regardless of the specific manner in which the blade airfoil or shells are attached to the inner platform and heat shield, the hot gases in the turbine must be prevented from infiltrating into any spaces between the recesses in the mentioned elements and blade airfoil resp. blade airfoil shells, so as to prevent undesired thermal inputs and to minimize flow losses.

If the blade airfoil is internally cooled with a cooling medium at a higher pressure than the hot combustion gases, excessive cooling medium leakage into the hot gas path can occur. To minimize such concerns, one or more additional seals can be provided in connection with the shell arrangement. The seal means can comprise one rope seals, W-shaped seals, C-shaped seals, E-shaped seals, a flat plate, or labyrinth seals. The seal means can consist of various materials including, for example, metals and/or ceramics.

Additionally, a thermal insulating material or a thermal barrier coating (TBC) can be applied to various portions of the blade assembly.

The main advantages and features of the present invention being as follows:
Thermo-mechanical decoupling of modules improves part lifetime compared to integral design.
Modules with different variants in cooling and/or material configuration can be selected to best fit to the different operating regimes of the gas turbine respectively power plant.
It is possible to introduce an inner spar comprising an extension from the root portion of the blade to the tip of the blade airfoil, and can be secured the inner spar to the attachment at the root portion by various connection means.
It is possible to introduce an inner spar comprising an extension from the root portion of the blade to the tip of the blade airfoil, wherein the spar having in the region of the shank a special contour in accordance with the contour of opposite cracks or clutches of footboard mounting parts.
The blade shank under-structure consisting, in radially direction of the airfoil, of an elongated and relatively slim formed portion. The elongated portion extends over the entire height of the footboard mounting part(s), wherein the foot-side end of the elongated portion having, along both sides of the axial expanse of this elongated portion, shapes of teeth, and the bottom of the elongated portion may be formed as a fir-tree-shaped cross-sectional profile. The teeth of the elongated portion may align with the recesses of two-piece footboard mounting parts to provide room for the teeth of the elongated portion. The footboard mounting parts having axially opposite cracks or clutches corresponding to the axially extending contour of the elongated portion for the reciprocal axial coupling.
The blade airfoil comprising a single outer shell, or interdependent shell, or intermediate shell components which can be selected in a manner to optimize component life, cooling usage, aerodynamic performance, and to increase the capabilities of resistance against high temperature stresses and thermal deformation.
The shells are segmented in various alternatives, wherein the individual part may be consisted in appropriate materials.
The capping or introduction of various inserts in connection with the inner platform and heat shield can be selected in a manner to optimize component life, cooling usage, aerodynamic performance, and to increase the capability of resistance against high temperature stresses and thermal deformations.
Root portion, inner platform, blade airfoil, heat shield and additional integrated elements can be completed with a selected thermal insulating material or a thermal barrier coating.
The spar having various passageways to supply a cooling medium through the blade.
The cooling of all above mentioned elements/modules of the blade consists mainly of a convective cooling, with selected impingement and/or effusion cooling.
The interchangeability or repairing and/or reconditioning of all elements/modules to one another are given as a matter of principle.
The fixation of the various elements/modules to one another can be consisted in means of a friction-locked connection actuated by adherence or through the use of a metallic and/or ceramic surface coating, or by bolts or rivets, or by HT brazing, active brazing or soldering.
The platforms may be composed of individual parts, which being on the one hand actively connected to the blade airfoil and shell elements and on the other hand being actively connected to rotor and stator.
The modular design of the blade airfoil facilitates the use of various materials in the structure of the shell, including materials which are dissimilar, in accordance with the different operating regimes of the gas turbine respectively power plant.
The modular blade assembly consisting of replaceable and non-replaceable elements, and besides the modular blade assembly comprising substitutable and/or non-substitutable elements.

In addition, the following summaries form an integral part of this description:
First summary: The blade airfoil has a pronounced or swirled aerodynamic profile in radially direction, is cast, machined or forged comprising additionally additive features with internal local web structure for cooling or stiffness improvements. Furthermore, the blade airfoil may be coated and comprising flexible cooling configurations for adjustment to operation requirements like, base-load, peak-mode, partial load of the gas turbine respectively power plant.
Second summary: Referring to the blade airfoil a preferred solution of this invention has a blade shank under-structure consisting, in radial direction of the airfoil, of an elongated and relatively slim formed portion. The elongated portion extends over the entire height of the footboard mounting part(s), wherein the foot-side end of the elongated portion having, along both sides of the axial expansion of the elongated portion, shapes of teeth, and the bottom of the elongated portion of the shank under-structure may be formed as a final part of the fir-tree-shaped cross-sectional profile. The teeth of the elongated portion of the shank under-structure may align with the recesses of two-piece footboard mounting parts to provide room for the teeth of the elongated portion.
Third summary: The inner platform is cast, forged or manufactured in metal sheet or plates. The inner platform is consumable in relation to predetermined cycles and replaced frequently as specified maintenance period and may be decoupled under other mechanical provisions from blade airfoil, wherein, supplementary, the inner platform may be mechanically connected to airfoil carrier using closure elements, namely bolts or rivets. The inner platform may be coated with CMC or ceramic materials.
Fourth summary, the shank is cast, forged or manufactured in metal sheet or plate. The shank is normally not consumable in relation to predetermined cycles and replaced as specified maintenance period and may be under other mechanically decoupled from blade airfoil, wherein the shank may be supplementary mechanically connected to airfoil using closure elements, namely bolts or rivets. The inner platform may be coated with CMC or ceramic materials.
Fifth summary: The footboard mounting parts consist essentially of inner platform, shank and fir-tree-shaped-shaped cross sectional portion having axially opposite cracks or clutches corresponding to the axially extending contour of the elongated portion of the shank under-structure for the reciprocal axial coupling.
Sixth summary: The assembly of the modules according to second and fifth summary is as follows: Separated footboard mounting parts (see fifth summary) and elongated blade airfoil (see second summary) are assembled by joining two correspond pieces of the footboard mounting parts with placing the underside elongated portion of the rotor blade airfoil between them before mounting the assembly to the rotor fir-tree recess. The modules may be sealed against each other by ceramic seal means or similar.
Seventh summary: If the blade airfoil is provided with an outer platform on the side of stator, this element is cast, forged or manufactured in metal sheet or plate. The outer platform is consumable in relation to predetermined cycles and replaced frequently as specified maintenance period and may be under other mechanically decoupled from the blade airfoil, wherein, supplementary, the outer platform may be mechanically connected to blade airfoil using closure elements, namely bolts or rivets. The outer platform may be coated with CMC or ceramic materials.
Eighth summary: The spar as under-structure of the flow-applied blade airfoil operating directly as under structure of the shell assembly, which is interchangeable, pre-fabricated or manufactured, in being single or multi-piece, uncooled or cooled, if cooled using convective and/or film and/or effusion and/or impingement cooling structure, having a web structure for cooling or stiffness improvement.
Ninth summary: The outer shell is an optional embodiment and represents the aero profile of the blade airfoil. The outer shell is interchangeable, consumable, pre-fabricated, using single or multi-piece with radial or circumferential patches and comprising variants in cooling and/or material configurations adapted to the different operating regimes of the gas turbine respectively power plant. The outer shell is joined to the intermediate shell or spar, may be used a shrinking assembly.
Tenth summary: The intermediate shell is an optional embodiment and may be required as compensator for potentially different thermal expansion of outer shell and spar and/or as cooling shirt for additional thermal protection of the spar. Also it provides additional protection of the spar in case the outer shell suffers damage by encumbrances, mechanical or thermal stresses or oxidation. The intermediate shell is interchangeable, consumable, pre-fabricated, using single or multi-piece with radial or circumferential patches and comprising variants in cooling and/or material configurations adapted to the different operating regimes of the gas turbine respectively power plant. The intermediate shell is joined to the spar, and may be used a shrinking assembly.
Eleventh summary: The insert elements and/or mechanical interlock are inserted at least in a force-fitting manner into appropriately designed recesses in the space of/or within a module of the blade, in the manner of a push loading drawer comprising additional fixing means, wherein the upper surface of the insert and/or mechanical interlock forming the respective flow-applied zone and may provide thermal protection of the modules.
Twelfth summary: The optional closing pieces may be crimped or welded on the various modules to secure assembly of all parts and may potentially provide thermal protection of the involved modules.

The foregoing and other features of the present invention will become more apparent from the following description and accompanying figures.

### BRIEF DESCRIPTION OF THE FIGURES

The invention shall subsequently be explained in more detail based on exemplary embodiments in conjunction with the drawing. In the drawing:

FIG. 1 shows an axial assembly of the rotor blade;

FIG. 2 shows a plan view according to FIG. 1;

FIG. 2a shows a three-dimensional view of the footboard mounting parts or elements

FIG. 2b shows a further three-dimensional view of the footboard mounting parts or elements

FIG. 3 shows an exemplary assembled rotor blade;

FIG. 4 shows a longitudinal section through the assembled rotor blade;

FIG. 5 shows a partial longitudinal section through the upper end of the rotor blade airfoil;

FIG. 6 shows a partial longitudinal section through the root portion of the rotor blade;

FIG. 7 shows a cross section through the rotor blade airfoil.

FIG. 8 shows a platform with inserts or mechanical interlocks optionally sealed by HT ceramics.

FIG. 9 shows a joining technology in the range of the tip of the rotor blade airfoil.

FIG. 10 shows a further joining technology in the range of the tip of the rotor blade airfoil.

### DETAILED DESCRIPTION OF EXEMPLARY EMBODIMENTS

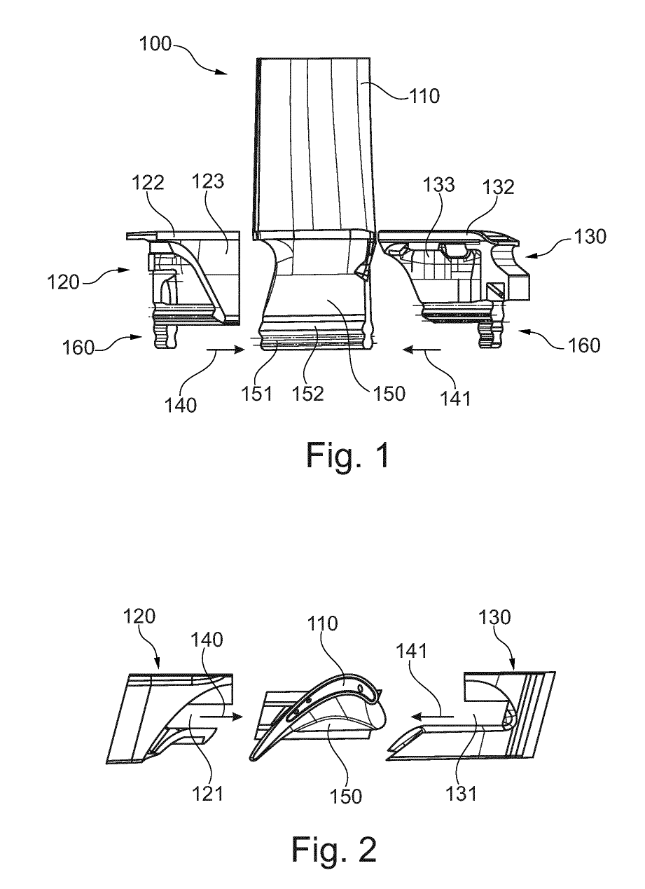

FIG. 1 shows a rotor blade assembly 100, comprising an airfoil 110 having a pressure side and a suction side and a rotor blade shank under structure consisting, in radially direction of the airfoil, of an elongated and relatively slim formed portion 150. The elongated portion 150 extends over the entire height of the footboard mounting part comprising inner platform 122/132, shank portion 123/133 and a root portion 160 with a fir-tree-shaped cross-sectional profile, which subject to the invention, namely the footboard mounting part is divided into at least two-folded footboard mounting elements 120, 130. The footboard mounting part may be consisted of several elements.

The foot-side end of the elongated portion 150 has opposed extending teeth 152, and the bottom of the elongated portion of the shank under structure may be formed as the final part 151 of the fir-tree-shaped cross-sectional profile 160. The teeth 152 of the elongated portion 150 of the shank under structure may align with the recesses of both separate footboard mounting elements 120, 130 to provide room for the teeth of the elongated portion 150.

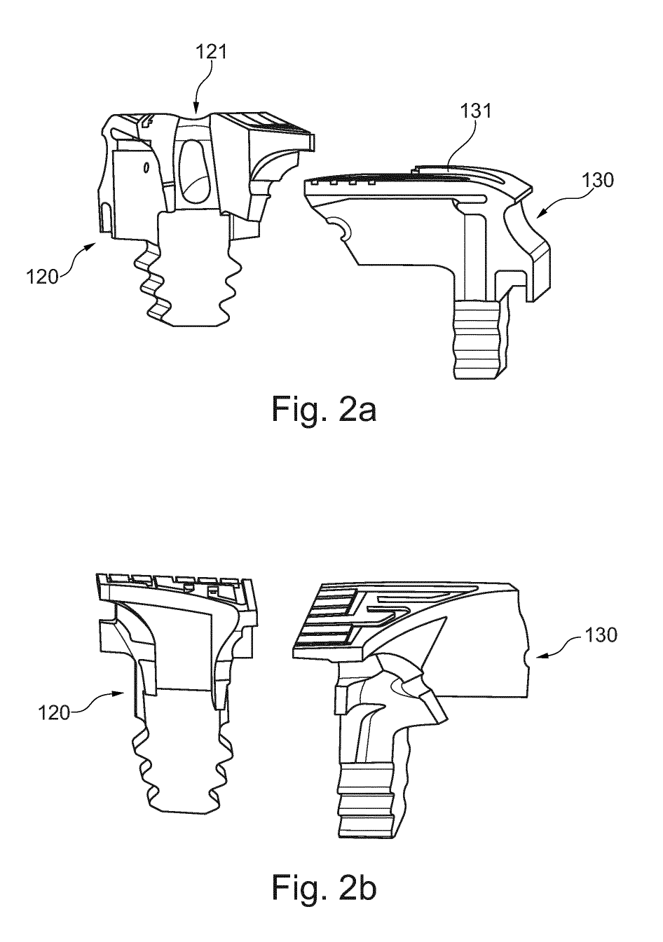

According to FIG. 2 the footboard mounting elements 120, 130 having axially opposite cracks or clutches 121, 131 corresponding to the axially extending contour of the elongated portion of the shank under structure 150 for the reciprocal axial coupling 140, 141. Additional geometric features such as grooves may be provided on the elongated portion of the shank under structure for interlocking with the both footboard mounting elements.

A further improvement in connection with the assembly of footboard mounting elements 120, 130 referring to the sealing structure, wherein the sealing must be designed preferably as joining without force transmission between rotor blade airfoil and footboard mounting parts elements 120, 130. In this context, reference is made to FIGS. 2a and 2b, from which emerges for a person skilled in the art the geometry of these parts.

Different types of seal come into question, namely:
a rope seal,
a brush seal,
a temperature-resistant filing material for ensuring a 100%-sealing without leakage losses with simultaneous avoidance of force transmission, for example by means of superplastic material,
other seals are also conceivable, which are suitable for this application purpose.

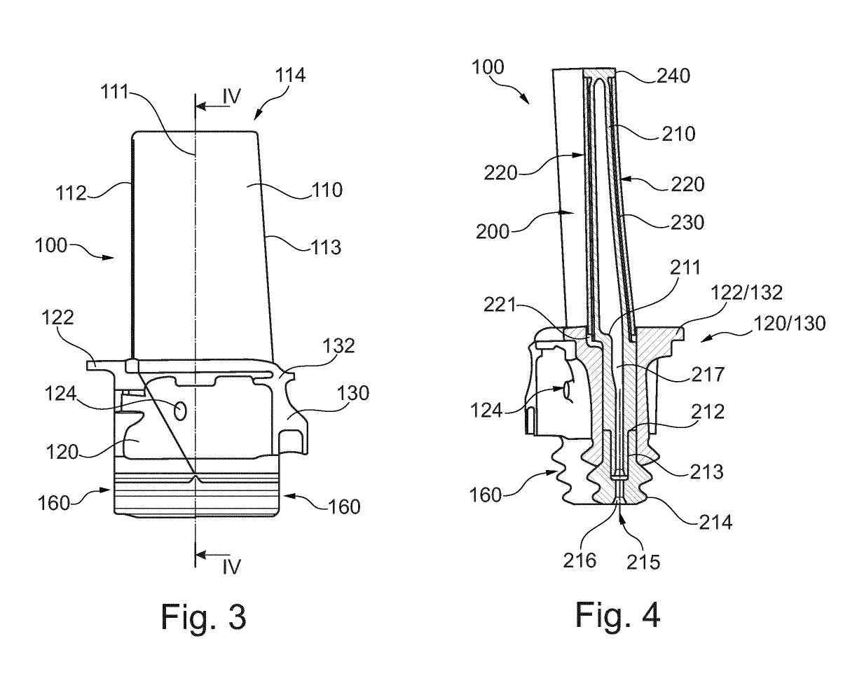

In FIG. 3 an assembled rotor blade 100 according to an exemplary embodiment of the invention is reproduced. The rotor blade 100 comprises a blade airfoil 110 which extends in the longitudinal direction of the rotor blade along a longitudinal axis 111.

The blade airfoil 110, which is delimited by a leading edge 112 and a trailing edge 113 in the flow direction, merges into a shank 120/130 at the lower end beneath an inner platform 122/132 which forms the inner wall of the hot gas passage, the shank terminating in a customary blade root portion 160 with a so called fir-tree-shaped cross-sectional profile by which the rotor blade 100 can be fastened on a blade carrier, especially on a rotor disk, by inserting into a corresponding axial slot.

The inner platform abuts the platforms of neighbouring blades to help define a gas passage inner wall for the turbine. An outer not specially shown heat shield at the tip of the blade airfoil 114 cooperates again with its neighbours in the manner shown to help define the outer wall of the turbine's gas passage.

Cooling passages, which are not shown, extend inside the blade airfoil 110 for cooling the rotor blade 100 and are supplied with a cooling medium, particularly cooling air, also via a feed hole 124 which is arranged on the shank 123 at the side (see FIG. 4). The shank 123/133 may consist of a concave and a convex side, similar to the blade airfoil 110. In FIG. 3 the convex side faces the viewer. The feed hole 124, which extends obliquely upwards into the interior of the blade airfoil 110, opens into the outside space on the convex side of the shank 120.

FIG. 4 shows a section taken from sectional lines IV-IV of FIG. 3. The embodiment of the rotor blade 100, generally illustrated with reference numeral 200, comprising outer shell assembly 220, intermediate shell 230, and generally elliptical shaped spar 210. The spar 210 extending longitudinally or in the radial direction from a root portion 160 to a tip embodiment 240 with a downwardly extending first portion 211 and a second portion 212 that fair into a rectangular shaped projection 213 that is adapted to fit into an attachment which is anchored in a final complementary portion 214 with the same outer contour compared to the fir-tree-shaped cross-sectional profile 160.

The shank 120/130 may be formed with the inner platform 122/132 may be formed separately and joined thereto and projects in a circumferential direction to abut against the inner platform in the adjacent rotor blade in the turbine disk (not shown). A seal (not shown) may be mounted between platforms of adjacent rotor blades to minimize or eliminate leakage around the individual rotor blades.

The tip 114 of the rotor blade 100 may be sealed by an embodiment 240 that may be formed integrally with the spar 210, or may be a separate piece that is suitably joined to the top end of the spar 210. The outer shell 220 extends over the surface of the spar 210 and is located in the central portion 221 and spaced from the outer surface of the spar 210.

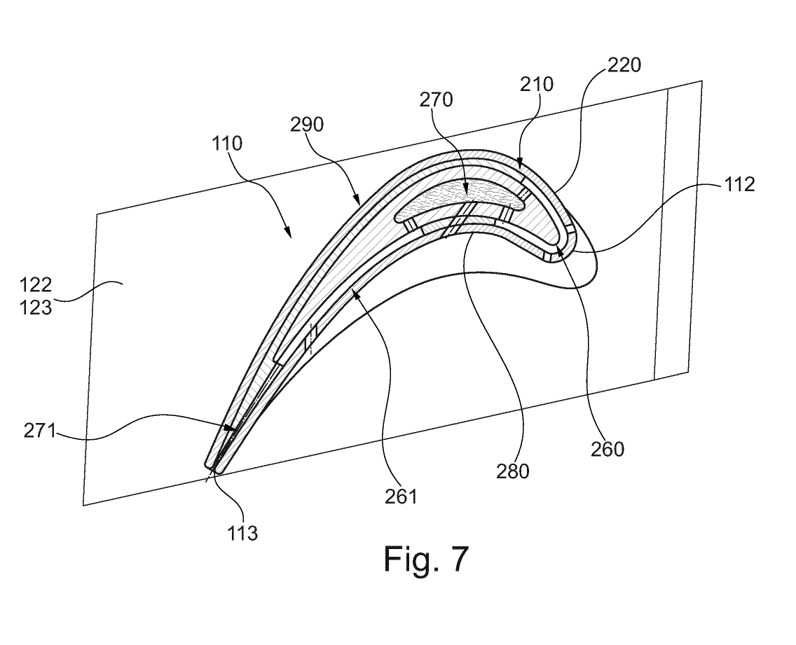

The outer shell 220 defines a pressure side (see FIG. 7), a suction side (see FIG. 7), a leading edge 112 and a trailing edge 113 (see also FIG. 3). As mentioned above the outer shell 220 may be consisted of different materials depending on the different operating regimes of the gas turbine. The outer shell 220 can consist of a single unit or be divided into various parts along the longitudinal axis 111 (see FIG. 3), similar to the spar 210.

As shown in FIG. 4, the cooling air 215 is additionally (see numeral 124) admitted through an inlet 216, the central opening formed at the ingress in the final complementary portion 214 and, subsequently, in the spar 210, and flows in a straight passage or interior cavity 217 in radially or quasi-radially direction.

According to FIG. 4 an intermediate shell 230 may be introduced. The intermediate shell 230 constitutes one of the important features of the invention. It may be required as a compensator for potentially different thermal expansion of outer shell 220 and spar 210 and/or cooling shirt for additional protection of the spar. The outer shell 220 is joined to the intermediate shell 230 or generally to the spar 210 by interference fit, wherein the intermediate shell 230 is also joined to the spar by interference fit, or generally by a shrinking joint.

Furthermore, the intermediate shell 230 provides additional protection to the spar 210 in case of damage of the outer shell 220. Basically, the intermediate shell 230 is an interchangeable module with variants in cooling and/or material configurations adapted to the different operating regimes of the gas turbine. If several superimposed shells are provided, they may be built with or without spaces between each other.

The internal cooling of the shells may be individually provided, or the cooling being operatively connected with the inner cooling of the blade airfoil.

Additionally, referring to FIG. 4, it can be introduced an additional retaining sleeve (not expressly shown) in the rectangular shaped projection 213.

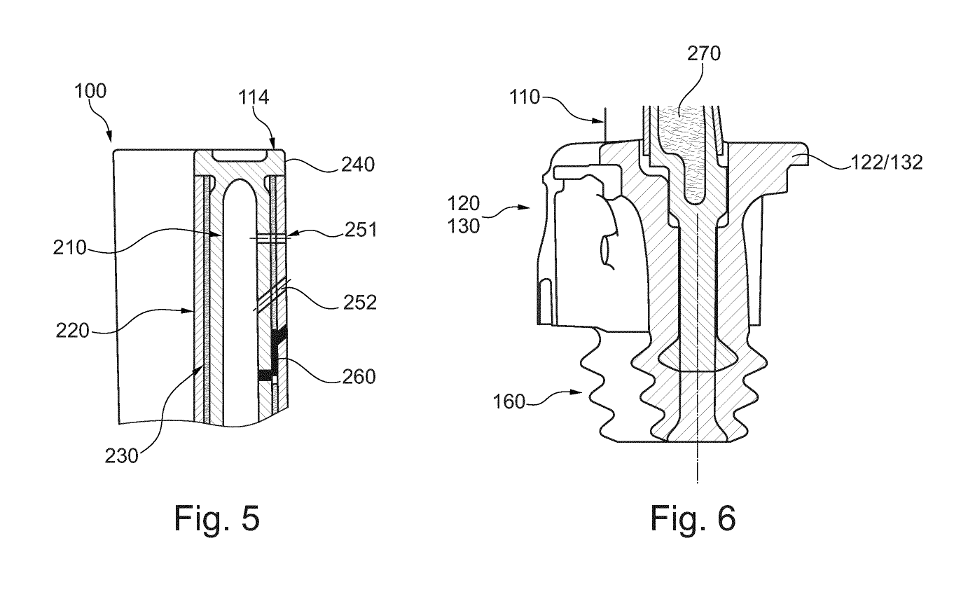

FIG. 5 shows a partial longitudinal section through the upper end of the blade airfoil. The tip 114 of the rotor blade 100 may be sealed by an embodiment 240 that may be formed integrally with the spar 210, or may be a separate piece that is suitably joined to the top end of the spar 210. The outer shell 220 extends over the surface of the spar 210. According to FIG. 5 an intermediate shell 230 may be made. The intermediate shell 230 constitutes one of the important features of the invention. It may be required as compensator for potentially different thermal expansion of outer shell 220 and spar 210 and/or cooling shirt for additional protection of the spar. The outer shell 220 is joined to the intermediate shell 230 or generally to the spar 210 by interference fit, wherein the intermediate shell 230 is also joined to the spar by interference fit.

Additionally, FIG. 5 shows different configurations of cooling holes 251, 252 through the elements of the rotor blade airfoil in partially or integrally manner. Furthermore, FIG. 5 shows a feeding cavity 260 in the intermediate shell 230. The spar 210 and the various shells 220, 230 are provided in the flow and peripheral directions with a number of regularly or irregularly distributed cooling holes 251, 252 having the most varied cross-sections and directions compared to the flow direction of the cooling medium. Through the cooling holes 251, 252 a cooling medium quantity flows outside of the rotor blade and an increase in the velocity being induced along the surface of the rotor blade.

FIG. 6 shows a partial longitudinal section through the root portion of the rotor blade. The interior cavity of the rotor blade airfoil (see FIG. 4, item 217) is integrally or partially filled with an appropriate filling material 270 which can exert various functions.

FIG. 7 shows a cross section through the rotor blade airfoil, comprising inner platform 122/123, pressure side 280, suction side 290, leading edge 112, trailing edge 113, outer shell 220 (a detailed intermediate shell is shown in FIGS. 4 and 5), spar, filling material 270 (see also FIG. 6), feeding cavities 260, 261, rib 271 situated in the region of the trailing edge 113 of the rotor blade airfoil 110.

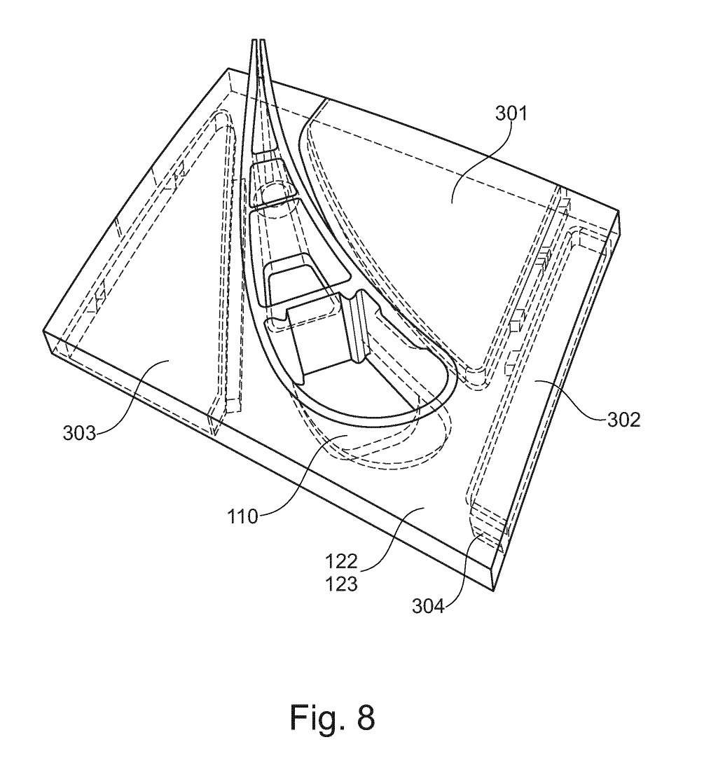

FIG. 8 shows a platform 122/123 of a rotor blade assembly with inserts and/or mechanical interlocks 301-303 optionally sealed by HT ceramics. This arrangement may involve inner and/or outer platform, and/or airfoil, and/or outer hot gas path liner, and are disposed along or within the caloric stress areas, namely the flow-applied zone of the rotor blade. The insert element and/or mechanical interlock forming the respective flow-applied zone are inserted at least in a force-fitting manner into appropriately designed recesses or in the manner of a push loading drawer with additional fixing means 304. Additionally, the insert element and/or mechanical interlock may be sealed by HT ceramics.

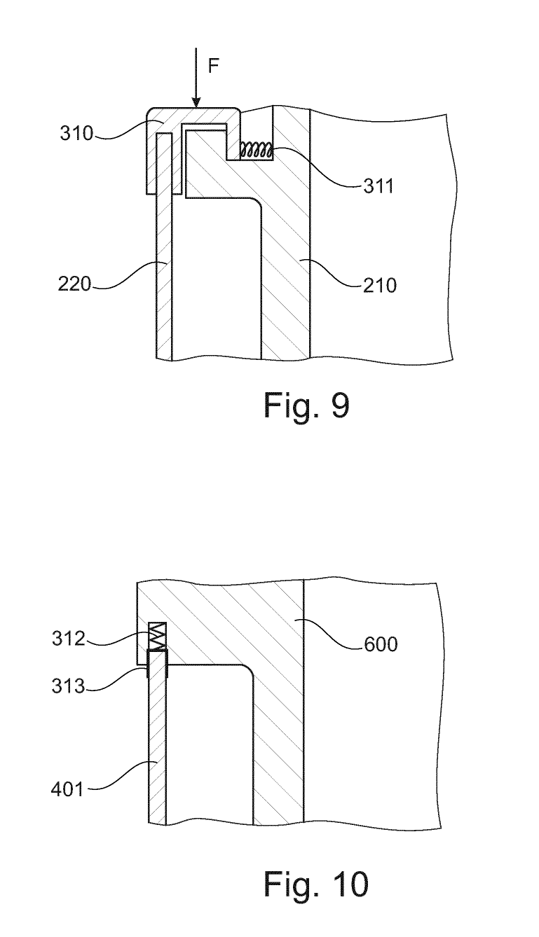

FIG. 9 shows a joining technology in the range of the tip of the rotor blade airfoil. Specifically, FIG. 8 shows the connection between the spar 210 and the outer shell 220. The mentioned elements 210, 220 are assembled with the aid of a force F acting metallic clamp 310 in axial direction. A spring 311 results actively connected to the metallic clamp 310 and the spar 210, and indirectly to the outer shell 220.

FIG. 10 shows a further joining technology in the range of the tip of the rotor blade. The assembly in connection with the outer shell 401 with respect to the spar 600 comprising a spring 312 and metallic cover element 313.

Important aspects of the shown joining in connection with FIGS. 9 and 10 are as follows: CMC or metallic outer shell is necessary to protect the sensitive metallic spar. Avoid point mechanical load, especially on the CMC, reduce risk of failure. Generally, good mechanical behaviour is waiting referring to CMC under compression on wide surface. With respect to fixing the CMC or metallic outer shell by brazing, soldering or using HT ceramic adhesives. The concept involves an interference fit with ceramic bush an compensator (spring) and fixation of CMC or metallic shell with metallic clamp and spring (FIG. 9) or by spring and metallic cover (FIG. 10).

Although this invention has been shown and described with respect to detailed embodiments thereof, it will be appreciated and understood by those skilled in the art that various changes in form and detail thereof may be made without departing from the spirit and scope of the claimed invention.

### LIST OF REFERENCES NUMEROUS

100 Rotor blade
110 Rotor blade airfoil
111 Longitudinal axis
112 Leading edge of the blade airfoil
113 Trailing edge of the blade airfoil
114 Tip of the blade airfoil
120 Footboard mounting element
121 Crack or clutches
122 Inner Platform
123 Shank portion
124 Feed hole
130 Footboard mounting element
131 Crack or clutches
132 Inner Platform
133 Shank portion
140 Reciprocal axial coupling
141 Reciprocal axial coupling
150 Elongated portion of the rotor blade airfoil
152 Opposed extending teeth
160 Root portion with a fir-tree-shaped cross-sectional profile
200 Embodiments of the rotor blade
210 Spar
211 Downwardly extending first portion
212 Downwardly extending second portion
213 Rectangular shaped portion
214 Final complementary portion
215 Cooling air or cooling medium
216 Inlet
217 Interior cavity
220 Outer shell
221 Central portion
230 Intermediate shell
240 Tip
251 Cooling holes
252 Cooling holes
260 Feeding cavity
261 Feeding cavity
270 Filling material
271 Rib
280 Pressure side
290 Suction side
301 Insert, mechanical interlock
302 Insert, mechanical interlock
303 Insert, mechanical interlock
304 Fixing means
310 Metallic clamp
311 Spring
312 Spring
313 Cover element

1. A rotor blade assembly for a turbomachine having a modular structure, wherein the blade assembly comprises:
blade elements each having at least one blade airfoil, and at least one footboard mounting part, wherein the blade elements each have one ending means for interchangeable connection among each other, wherein the connection of the airfoil with respect to other elements is based on a fixation in radial or quasi-radial extension compared to an axis of the rotor of a turbomachine, wherein assembling of the blade airfoil in connection with the footboard mounting part is based on a friction-locked bonding actuated by adherence interconnecting, or the assembling of the blade airfoil in connection with the footboard mounting part is based on the use of a metallic and/or ceramic surface fixing blade elements to each other, or the assembling of the blade airfoil in connection with the footboard mounting part is based on closure means with a detachable, permanent or semi-permanent fixture, wherein the footboard mounting part includes at least two-folded elements, wherein the assembly of separated footboard mounting parts with respect to a foot-side elongated portion of the blade airfoil is conducted with a reciprocal axially guided coupling, wherein the footboard mounting parts have axially opposite cracks or clutches corresponding to an axially extending contour of the elongated portion of the shank under-structure, wherein the axially extending contour of an elongated portion of a shank under structure corresponds approximately to an axially inflow plane of an airfoil.

2. A blade assembly of a power plant based on a modular structure, modularity blade assembly comprises:
blade elements having at least one blade airfoil, and at least one footboard mounting part, wherein the blade elements each have one ending means interchangeable connection among each other, wherein the connection of the airfoil with respect to other blade elements is based on a fixation in radially or quasi-radially extension compared to an axis of a turbomachine, wherein assembling of the blade airfoil in connection with the footboard mounting part is based on a friction-locked bonding actuated by adherence interconnecting, or the assembling of the blade airfoil in connection with the footboard mounting part is based on use of a metallic and/or ceramic surface fixing blade elements to each other, or the assembling of the blade airfoil in connection with the footboard mounting part is based on closure means with a detachable, permanent or semi-permanent fixture, wherein the footboard mounting part includes at least two-folded elements, wherein the assembly of separated footboard mounting parts with respect to a foot-side elongated portion of the blade airfoil is conducted with a reciprocal axially guided coupling, wherein an interior cavity of the blade airfoil or spar is partially or integrally filled with selected material.

3. A blade assembly of a power plant based on a modular structure, wherein the blade assembly comprises:
blade elements having at least one blade airfoil, and at least one footboard mounting part, wherein blade elements each have one ending means for interchangeable connection among each other, wherein the connection of the airfoil with respect to other blade elements is based on a fixation in radial or quasi-radial extension compared to an axis of a rotor of a turbomachine, wherein the assembling of the blade airfoil in connection with the footboard mounting part is based on a friction-locked bonding actuated by adherence interconnecting, or the assembling of the blade airfoil in connection with the footboard mounting part is based on use of a metallic and/or ceramic surface fixing blade elements to each other, or the assembling of the blade airfoil in connection with the footboard mounting part is based on closure means with a detachable, permanent or semi-permanent fixture, wherein the footboard mounting part includes at least two-folded elements, wherein the assembly of separated footboard mounting parts with respect to a foot-side elongated portion of the blade airfoil is conducted with a reciprocal axially guided coupling, wherein the assembly of an outer shell in a range of a tip of the blade airfoil includes at least one compensator for collecting caloric dilations.

4. The blade assembly according to claim 1, wherein the footboard mounting parts comprise: at least one inner platform, a shank, and a root portion having a fir-tree-shaped cross-sectional profile.

5. The blade assembly according to claim 1, wherein the assembly between the elongated portion of the blade airfoil and the footboard mounting elements comprises: a sealing structure.

6. The blade assembly according to claim 1, wherein the blade airfoil comprises: at least one flow-applied outer shell encasing at least one part of the blade airfoil, complying with aerodynamic aspects of the blade.

7. The blade assembly according to claim 1, wherein a flow-applied outer shell encases integrally an outer contour or an understructure of the blade airfoil.

8. The blade assembly according to claim 7, wherein the understructure of the blade airfoil consists of: a spar which extends from the footboard mounting part of the blade to the tip of the blade airfoil.

9. The blade assembly according to claim 1, wherein a flow-applied outer shell encases partially an outer contour of the blade airfoil in a flow direction of a working medium of a turbomachine.

10. The blade assembly according to claim 9, wherein the partially provided flow-applied outer shell is actively connected to a leading edge of the blade airfoil.

11. The blade assembly according to claim 1, wherein a flow-applied outer shell encases integrally an outer contour of the blade airfoil, wherein the outer shell includes a single body.

12. The blade assembly according to claim 1 wherein a flow-applied outer shell comprises: on an inside, an intermediate arranged non flow-applied or partially flow-applied shell.

13. The blade assembly according to claim 12, wherein both shells are disposed adjacent or distanced from one another.

14. The blade assembly according to claim 1, wherein at least one flow-applied outer shell encases integrally an outer contour of the blade airfoil, the outer shell including at least two bodies forming partially or integrally the outer contour of the blade airfoil.

15. The blade assembly according to claim 14, wherein bodies forming partially or integrally the outer shell are brazed or welded along their radial or circumferential interface.

16. The blade assembly according to claim 14, wherein bodies forming partially or integrally the outer shell comprises: radial or quasi-radial gaps, which are filled with a seal and/or ceramic material.

17. The blade according to claim 1, wherein a flow applied outer shell is connected to the blade airfoil or under-structure of the airfoil using a shrinking joint.

18. The blade assembly according to claim 1, wherein the means for interchangeable connection of the blade elements/modules, between the blade airfoil, an inner platform, a shank, a root portion, a heat shield, or between the blade airfoil and the element of the footboard mounting part elements comprise: reciprocal lugs or recesses are based on a friction-locked bonding or permanent connection.

19. The blade assembly according to claim 1, wherein the inner platform and heat shield comprises at least one insert and/or additional thermal barrier coating along caloric stress areas.

20. The blade assembly according to claim 1, wherein the inner platform and the heat shield comprise at least one insert and/or mechanical interlock on thermal stress areas, wherein the insert and/or mechanical interlock us configured to comply with aerodynamic aspects of the platform or heat shield.

21. The blade assembly according to claim 1, wherein an insert element and/or mechanical interlock are inserted at least in a force-fitting manner into appropriately configured recesses in a space of or within an element of the blade, as a push loading drawer including additional fixing means, wherein the upper surface of the insert element and/or mechanical interlock form the respective flow-applied zone.

22. The blade assembly according to claim 21, wherein the insert element or mechanical interlock and/or additional thermal barrier coating are situated along thermal stress areas.

23. The blade assembly according to claim 1, wherein an internal cooling path of the blade airfoil is actively connected to the cooling structure of the flow-applied outer shell, and/or flow-applied intermediate shell and/or inner platform and/or heat shield.

24. The blade assembly according to claim 23, wherein the cooling structure corresponds to a convective and/or film and/or effusion and/or impingement cooling procedure.

25. The blade assembly according to claim 1, wherein the blade airfoil is configured with a pronounced or swirled aerodynamic profile in radial direction.

26. A method of assembling a blade based on a modular structure according to claim 1, wherein blade elements have at least one blade airfoil, and at least one footboard mounting part, wherein the blade elements each have one ending means interchangeable connection among each other, wherein the connection of the airfoil with respect to other blade elements is based on a fixation in radial or quasi-radial extension compared to the axis of the gas turbine, wherein the assembling of the blade airfoil in connection with the footboard mounting part is based on a friction-locked bonding actuated by adherence interconnecting, or the assembling of the blade airfoil in connection with the footboard mounting part is based on use of a metallic and/or ceramic surface fixing blade elements to each other, or the assembling of the blade airfoil in connection with the footboard mounting part is based on closure means with a detachable, permanent or semi-permanent fixture, wherein the footboard mounting part includes at least two-folded elements, wherein
the assembly of separated footboard mounting parts with respect to a foot-side elongated portion of the blade airfoil is conducted with a reciprocal axially guided coupling, wherein the footboard mounting parts include:
axially opposite cracks or clutches corresponding to the axially extending contour of the elongated portion of the shank under-structure, and
wherein the axially extending contour of the elongated portion of the shank under structure corresponds approximately to an axially inflow plane of the airfoil.
